(19) United States
(12) Patent Application Publication
(10) Pub. No.: US 2022/0012635 A1
(43) Pub. Date: Jan. 13, 2022

(54) ANALYTIC TECHNIQUES FOR IMPROVED SUPER TILING MACHINE LEARNING PROCESSING

(71) Applicant: Texas Instruments Incorporated, Dallas, TX (US)

(72) Inventors: Rishabh GARG, Patiala (IN); Pramod Kumar SWAMI, Bengaluru (IN); Kumar DESAPPAN, Bengaluru (IN); Anshu JAIN, Bengaluru (IN)

(21) Appl. No.: 17/327,869

(22) Filed: May 24, 2021

(30) Foreign Application Priority Data
Jun. 18, 2020 (IN) 202041025785

(51) Int. Cl. G06N 20/00; G06K 9/62; G06F 11/30

(52) U.S. Cl. CPC G06N 20/00; G06F 11/3037; G06K 9/6202

(57) ABSTRACT

Techniques for enhancing machine learning (ML) model execution. The technique includes determining an amount of memory used to process layers of a machine learning network having multiple layers, smoothing the amount of memory used to process the layers of the machine learning network based on a number of layers, identifying change layers where the smoothed amount of memory used changes more than a memory change threshold amount, grouping the layers of the machine learning network into a first layer grouping based on the identified change layers, and outputting the first layer grouping.

### CROSS-REFERENCE TO RELATED APPLICATIONS

This application claims priority to India Provisional Application No. 202041025785, filed Jun. 18, 2020, which is hereby incorporated by reference.

### BACKGROUND

Machine learning (ML) is becoming an increasingly important part of the computing landscape. Machine learning is a type of artificial intelligence (Al) and ML helps enable a software system to learn to recognize patterns from data without being directly programmed to do so. Neural networks (NN) are a type of ML which utilize a set of linked and layered functions (e.g., node, neuron, etc.) which are weighted to evaluate input data. In some NNs, sometimes referred to as convolution neural networks (CNNs), convolution operations may be performed in NN layers based on inputs received and weights. A convolution operation is a mathematical transformation applied to two functions to produce a third function which expresses how the shape of one function is modified by the second function. Examples of CNNs include deconvolutional neural networks, pooling neural networks, up-sample neural networks, deep neural networks, etc. CNNs are often used in a wide array of applications typically for recognition and classification, such as image recognition and classification, prediction and recommendation systems, speech and language recognition and translation, etc.

As ML becomes increasingly useful, there is a desire to execute complex ML techniques, such as NNs and CNNs, efficiently in devices with relatively limited compute and memory resources, such as embedded, or other low-power devices. To help efficiently run a given ML model on target hardware resources, the ML model may be analyzed and optimized to run using super tiling to tailor the ML model for the target hardware resources to be used.

### SUMMARY

This disclosure relates to a technique for enhancing ML model execution. The technique includes determining an amount of memory used to process layers of a machine learning network having multiple layers, smoothing the amount of memory used to process the layers of the machine learning network based on a number of layers, identifying change layers where the smoothed amount of memory used changes more than a memory change threshold amount, grouping the layers of the machine learning network into a first layer grouping based on the identified change layers, and outputting the first layer grouping.

Another aspect of the present disclosure relates to a non-transitory program storage device comprising instructions stored thereon to cause one or more processors to: determine an amount of memory used to process layers of a machine learning network having multiple layers, smooth the amount of memory used to process the layers of the machine learning network based on a number of layers, identify change layers where the smoothed amount of memory used changes more than a memory change threshold amount, group the layers of the machine learning network into a first layer grouping based on the identified change layers, and output the first layer grouping.

Another aspect of the present disclosure relates to device, comprising: a memory, and one or more processors operatively coupled to the memory, wherein the one or more processors are configured to execute non-transitory instructions causing the one or more processors to: determine an amount of memory used to process layers of a machine learning network having multiple layers, smooth the amount of memory used to process the layers of the machine learning network based on a number of layers, identify change layers where the smoothed amount of memory used changes more than a memory change threshold amount, group the layers of the machine learning network into a first layer grouping based on the identified change layers, and output the first layer grouping.

### BRIEF DESCRIPTION OF THE DRAWINGS

For a detailed description of various examples, reference will now be made to the accompanying drawings in which:

FIG. 1 illustrates a dataflow through an example CNN, in accordance with aspects of the present disclosure.

FIG. 2 illustrates tiling for a tensor, in accordance with aspects of the present disclosure.

FIG. 3A is a block diagram illustrating super tile processing, in accordance with aspects of the present disclosure.

FIG. 3B is a block diagram illustrating super the processing resource usage, in accordance with aspects of the present disclosure.

FIG. 4 illustrates super tile processing for multiple super tile passes, in accordance with aspects of the present disclosure.

FIGS. 5A and 5B illustrate super the processing for multiple super tile passes across multiple super the groups, in accordance with aspects of the present disclosure.

FIG. 6A is a line graph plotting the total volume of memory used for each layer of a CNN, in accordance with aspects of the present disclosure.

FIG. 6B is a line graph plotting a windowed total volume of memory for layers of a CNN, in accordance with aspects of the present disclosure.

FIGS. 7A and 7B are flowcharts illustrating group boundary determination, in accordance with aspects of the present disclosure.

FIG. 8 is a flow diagram illustrating a technique for determining a layer grouping, in accordance with aspects of the present disclosure.

FIG. 9 is a block diagram of an example of a computing device, in accordance with aspects of the present disclosure.

### DETAILED DESCRIPTION

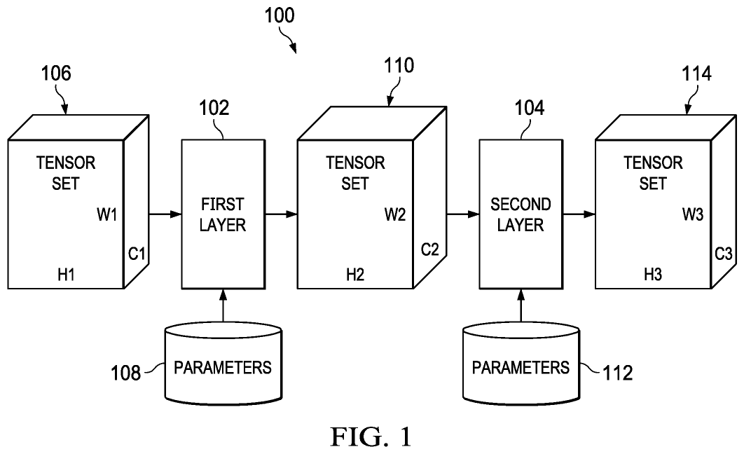

FIG. 1 illustrates a dataflow through an example CNN 100, in accordance with aspects of the present disclosure. The CNN 100 shown here includes two layers, first layer 102 and second layer 104. While this example CNN includes two layers, it may be understood that other CNNs can include any number of layers. The layers represent a mathematical function performed for an input tensor and result in an output tensor. Examples of the mathematical functions include convolution/deconvolution functions, pooling, elementwise add, concatenate, etc. The tensors are generalized matrices of N dimensions and include one or more nodes, which contain values. As an example, for an image, a node may describe a pixel and may include values for an x and y coordinate of the pixel as well as values for the R, G, and B channels describing the color of the pixel. The tensor may have a height axis, here represented by H1, H2, H3 and width axis W1, W2, and W3 corresponding to the dimensions of the image, as well as a channel axis, represented by C1 C2, and C3, corresponding to the color channel information (RGB information). In this example, a first tensor 106 is input into the first layer 102 along with a set of operational parameters 108 to produce a second tensor 110. Similarly, the second tensor 110 may be input into the second layer 104, processed based on operation parameters 112 and output a third tensor 114. The operational parameters 108 and 112 may include, for example, weights to apply to the processing of a given layer. Generally, the initial tensor, such as the first tensor 106 is the input into the CNN 100, and the last tensor, here the third tensor 114, is the output from the CNN 100. Tensors in between the input and output tensor, here the second tensor 110, may be referred to as intermediate tensor.

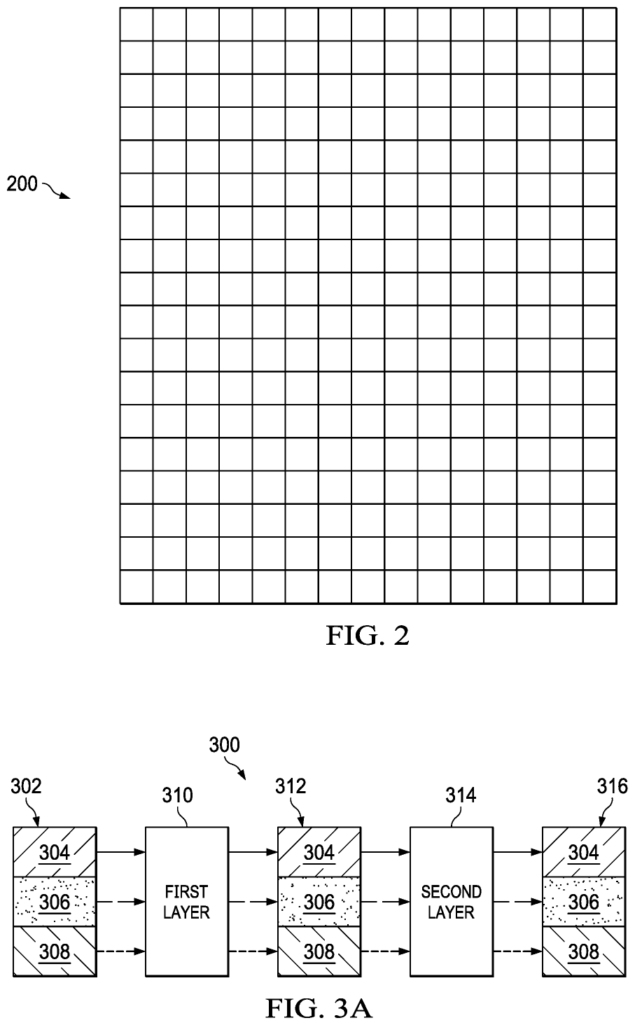

In certain cases, a tensor may be split into tiles for processing, as shown in tensor 200 of FIG. 2, where the tiles may be sized based, for example, on the pipeline design of the processor. For example, a tile may include one or more nodes based on a number of parallel pipelines available on a processor. Of note, going forward, tensors are shown as two-dimensional structures for the sake of clarity. In common implementations, all tiles of a given tensor are processed by a particular layer before processing starts on the next tensor and layer. For example, referring back to FIG. 1, processing of the first tensor 106 in the first layer 102 may be completed for the entire first tensor 106 and output to the second tensor 110 before processing of the second tensor 110 in the second layer 104.

Generally, it is advantageous to be able to store as much information required to execute a CNN in a memory as close as possible to the processor to help performance. Generally, memory close to a processer may be referred to as on-chip memory, while memory that is relatively further from the processor may be referred to as system memory, main memory, or random-access memory (RAM), and even further memory may be referred to as storage, disk, or hard disk. Examples of on-chip memory include static random-access memory (SRAM) and cache memory. Cache memory may further be divided into levels, such as level 1 (L1), level 2 (L2), and level 3 (L3), with higher numbers generally indicating that the cache is further away (e.g., slower to access) from the processor. As an example of processing an intermediate input tensor in a corresponding layer, the input tensor may be stored in a level 3 (L3) memory cache, while weights, CNN model, and input the and output information are stored in a level 2 (L2) cache. As portions of the tensor are processed, output may be stored temporarily in L2 cache and then output to another intermediate tensor, for example, in L3 cache as the input tensor is processed. Outputting the next tensor into the L3 cache helps prepare the system to process the next layer. In certain cases, the initial input tensor and final output may be stored in system memory. Storing and accessing intermediate tensors entirely in cache helps reduce the need to access external memory, such as system memory, like double data rate (DDR) memory, which can take a number of dock cycles (e.g., processing cycles) and reduce processing efficiency as the processor may need to stall while waiting for data.

While the size of a memory may be fixed, the size required by an intermediate tensor can vary. For example, a CNN may have a half megabyte (MB) sized input tensor and may be associated with two intermediate tensors of 5 MB and 12 MB, respectively. If, for example, a near processor memory such as a L3 cache is only 8 MB, the 12 MB intermediate tensor will not be able to entirely fit within the L3 cache and a portion of the 12 MB intermediate tensor will likely be stored in system memory. As memory access to system memory take substantially longer than accessing cache memory, in this case, processing times for the 12 MB intermediate tensor would be bottlenecked by memory input/output times.

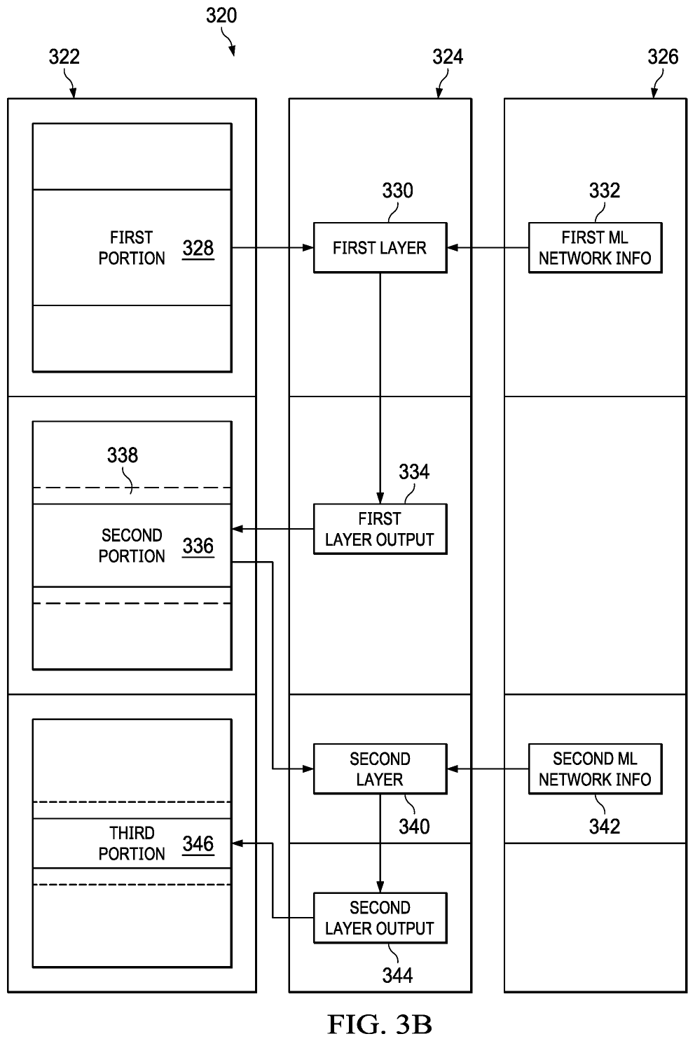

FIG. 3A is a block diagram illustrating super the processing 300, in accordance with aspects of the present disclosure. Rather than processing an entire tensor through a layer before processing the next tensor and layer, a portion of a tensor may be processed across multiple layers as a super the before the next super tile is processed. For example, as shown in FIG. 3, the first tensor 302 may be divided into three portions, or super tiles, super the 304, 306, and 308. Super the 304 may be processed in the first layer 310 to output super the 304, which is a portion of a second tensor 312. Similarly, super the 304 of the second tensor 312 may then be processed in the second layer 314 to output super the 304 of third tensor 316. Super the 304 is thus processed across multiple layers before super the 306 is processed. In this example, the super the performed across the height axis or dimension. In other cases, super tiling may be performed in other axis, such as the horizontal or vertical axis by removing values from one dimension of a tensor. After super tile 304 is processed by a set of layers, super tile 306 is then processed by the set of layers. After processing of super tile 306 is complete, super tile 308 is then processed by the set of layers.

In certain cases, a portion of an input tensor is overwritten by a corresponding output of processing that portion of input tensor. FIG. 3B is a block diagram illustrating super tile processing resource usage 320, in accordance with aspects of the present disclosure. This example illustrates an on-chip memory 322, a processor 324 and another memory 326. In this example, the memory 322 includes a first portion 328 of a first tensor. The first portion 328, in this example, may be an intermediate tensor output from a previous layer (not shown). The first portion 328 may be processed in a first layer 330 in conjunction with first ML network information 332 with model and/or weight information to produce a first layer output 334. The first output 334 is written back into the on-chip memory 322, overwriting portions of the on-chip memory 322 which were storing the first portion 328 to obtain a second portion 336 of a second tensor. In certain cases, the second portion 336 may be a different size than the first portion 328. When the second portion 336 is smaller in size as compared to the first portion 328, the remaining portions 338 of the first portion 328 may be discarded. In certain cases, output from the first layer 332 may be dynamically written over corresponding parts of the first portion 328 in the on-chip memory 322 as the output is generated. Once generated, the second portion 336 is processed in a second layer 340 in conjunction with second ML network information 342 to produce a second layer output 344, which is written back into the on-chip memory 322, overwriting portions of the on-chip memory 322 which were storing the second portion 336 to obtain a third portion 346 of a third tensor.

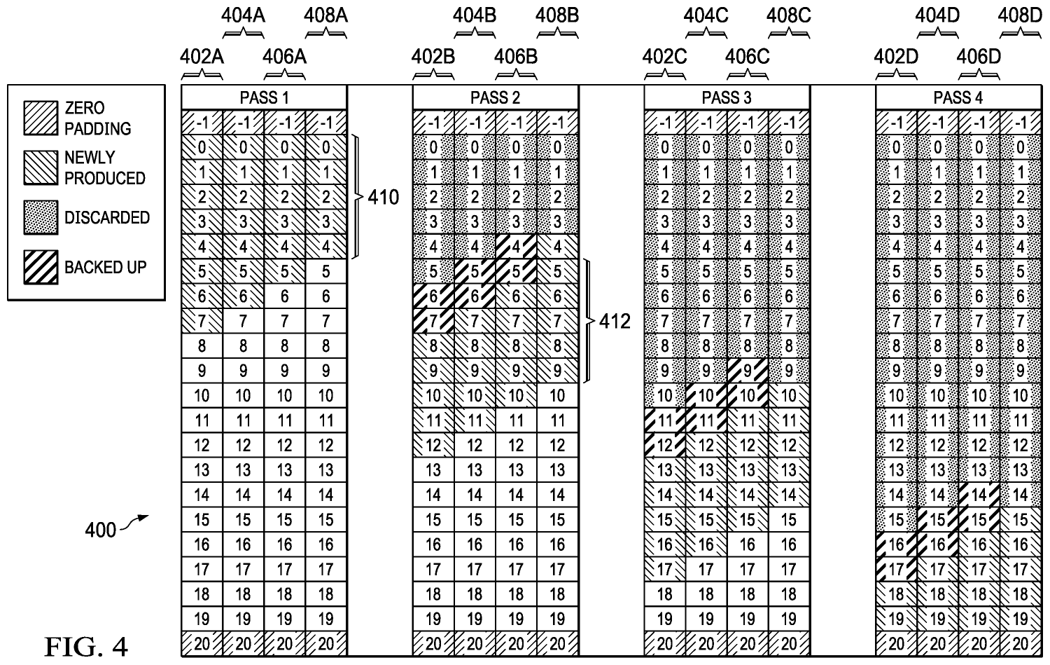

FIG. 4 illustrates super tile processing for multiple super tile passes 400, in accordance with aspects of the present disclosure. This example includes a layer group with at least the four intermediate tensors, a first tensor 402A-402D, second tensor 404A-404D third tensor 406A-406D, and fourth tensor 408A-40D, which are shown here in a single dimension with 20 tiles, with other dimensions omitted for clarity. In this example, the layers have also been omitted. Of note, as the tensors 402-408 in this example are intermediate tensors, the first tensor 402 is an output tensor from a separate input tensor (not shown) and corresponding layer. As before, the first tensor 402 is input into a first layer to generate the second tensor 404, which is input into a second layer to generate the third tensor 406, which is input into a third layer to generate the fourth tensor 408. Four super tile passes are used to generate the complete fourth tensor 408, which may be input into another layer, for example, another layer outside of this layer group.

Each of the layers discussed in this example are 3×3 convolution layers. In a 3×3 convolution layer, each tile is processed along with one neighboring tile in each dimension for the layer. Each tensor includes two zero pads, represented by the −1 and 20 entries. These zero pads may be used as neighboring tiles when processing tiles on the edge of a given tensor. Here at the end of each super tile pass, the fourth tensor 408 has five completed tiles 410. As each layer is a 3×3 convolution layer, tile 5 of the third tensor 406A is used to generate tile 4 of the fourth tensor 408A. likewise, tile 6 of the second tensor 404A is used to generate tile 5 of the third tensor 406A, and so forth. After the first super tile pass is completed, the second super tile pass is performed. As with the first super tile pass, five completed tiles 412 are generated after the second super tile pass the completed. As discussed in conjunction with FIG. 4, there may be overlapping areas as between the super tile passes. For example, tiles 4 and 5 for the third tensor 406B may be used to generate the five completed tiles 412 of the fourth tensor 408B. Tiles 4 and 5 of the third tensor 406B were previously computed in the first super tile pass and stored. When generating the third tensor 406B, tiles 4 and 5 of the third tensor 406B are reloaded rather than being recomputed. Similarly, tiles 5 and 6 of the second tensor 404B and tiles 6 and 7 of first tensor 402B may also be reloaded. In certain cases, a number of tiles included within a super tile may vary across super tile passes. For example, for the fourth super tile pass, the first tensor 402D may have two tiles, rather than eight tiles as in the other super the passes. In cases where the size of the tensors varies across the layer group, the size of the largest tensor may be used as a part of determining a size for the super tiles. In this example, as each prior layer requires more tiles to be calculated than the next, the size, and hence memory space required to calculate the tiles of the first tensor 402A for the first pass, would be a limiting factor to the size of the overall super tile. That is, the size of the super tile (e.g., tile height) may be selected to allow the calculations needed for the first tensor 402A in the first pass to fit into a memory, such as the L3 cache.

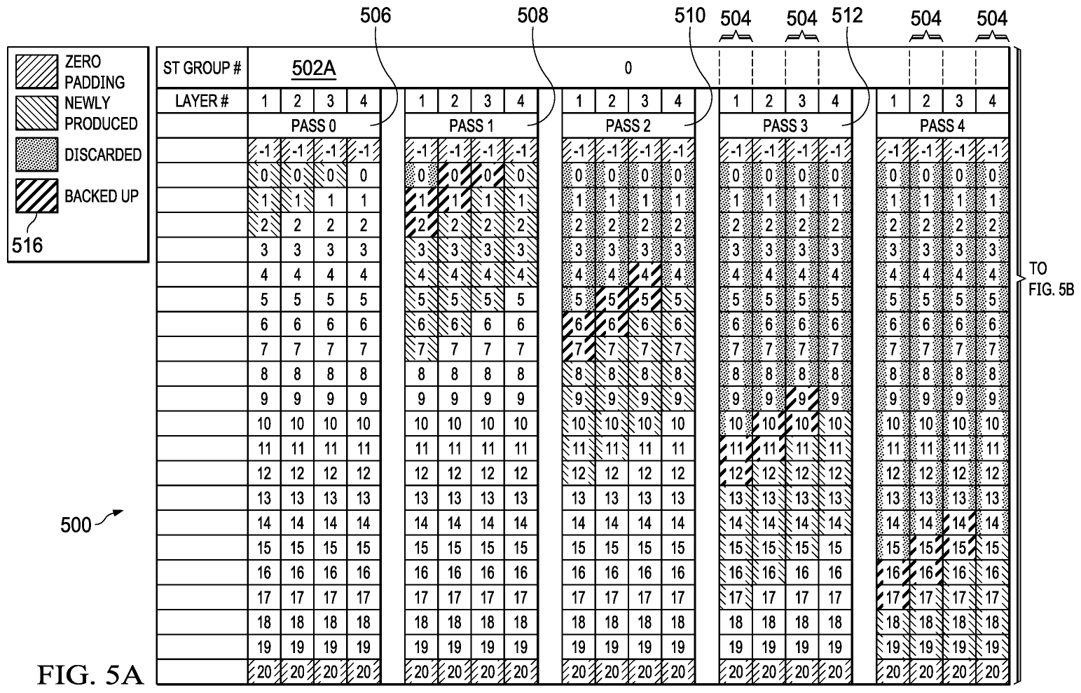

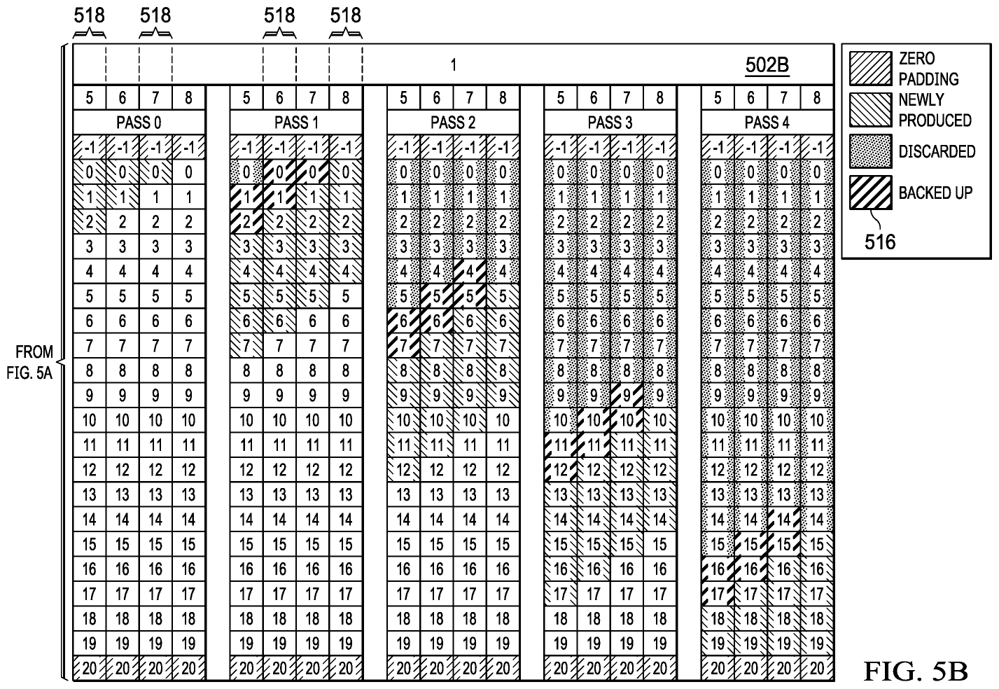

FIGS. 5A and 5B illustrate super tile processing 500 for multiple super tile passes across multiple super tile groups, in accordance with aspects of the present disclosure. Generally, a CNN may have any number of layers and in some cases, a particular CNN may have more layers than can be practically run as a single super tile. For example, CNNs with a relatively large input tensors and relatively small output tensors, it may be beneficial to execute the layers of the CNN in multiple super tiles, rather than a single super tile. In some cases, the layers of the CNN may be grouped into super tile groups 502A and 502B (collectively 502) with one or more layers grouped into each super tile group 502.

Each super tile group may be associated with certain super tile group properties. These super tile group properties may include properties such as a number of layers in the super tile group, tile heights associated with the layers, and a context memory. In this example, the number of layers in a first super tile group 502A includes four layers 504, here layers 1, 2, 3, and 4. A second super tile group 502B, in this example, also includes four layers 518, here layers 5, 6, 7, and 8. It may be understood that each super tile group may have a different number of layers. Each layer may be associated with one or more tile heights. In some cases. each layer may be associated with a first tile height, a normal tile height, and a last the height. The first tile height may indicate a number of tiles for each layer during the first run. In some cases, the first run may be a virtual or prewarming super tile pass, here labeled as pass 0 506. The virtual super tile pass may not produce a completed tile in the last tensor of the layer group. Rather, the virtual super tile pass computes a set of tiles which overlaps with tiles of the next, normal super tile pass and stores these (e.g., backed up) computed tiles for the next pass. In this example, the first tile height, for the first layer is 3, the second layer is 2, the third layer is 1, and the fourth layer is 0.

The normal tile height may indicate a number of tiles for each layer during a steady state run of the super tile passes, here labeled as pass 1 508, pass 2 510, and pass 3 512. In this example, the normal tile height for all of the layers is 5. It may be understood that the normal tile height for each layer may be different. The last tile height indicates a number of tiles for each layer for the last pass, here pass 4 514, of the super tile run. In this example, the last tile height, for the first layer is 2, the second layer is 3, the third layer is 4, and the fourth layer is 5.

The context memory super tile group property refers to the stored or backed up tiles 516 for the passes. In this example, the context memory size is six tiles.

Super tile groups and associated super tile group properties may be defined for a CNN to help tailor the execution of the CNN for certain hardware resources. Each CNN may have a unique combination of a number of layers, tensor dimensions for each layer, and what each layer may be doing. For example, certain layers, such as layers performing a pooling function, convolution function, etc., may be associated with a down-sampling property where the layer takes an input tensor of a certain dimension and outputs a tensor with reduced dimensions. Other layers, such as layers performing a resizing function, deconvolution function, etc., may be associated with an up-sampling property where the layer takes an input tensor of a certain dimension and outputs a tensor with increased dimensions,

To help tailor the execution of the CNN for a given hardware resource, the CNN may be modeled to determine a total volume of memory (e.g. an amount of memory) needed for each layer of the CNN. This total volume of memory may include all memory needed to execute the layer of the CNN, including memory needed for the input tensor(s), output tensor(s), backed up tiles, operational parameters needed for the layer, etc. Super tile groups may be defined based on this total volume of memory.

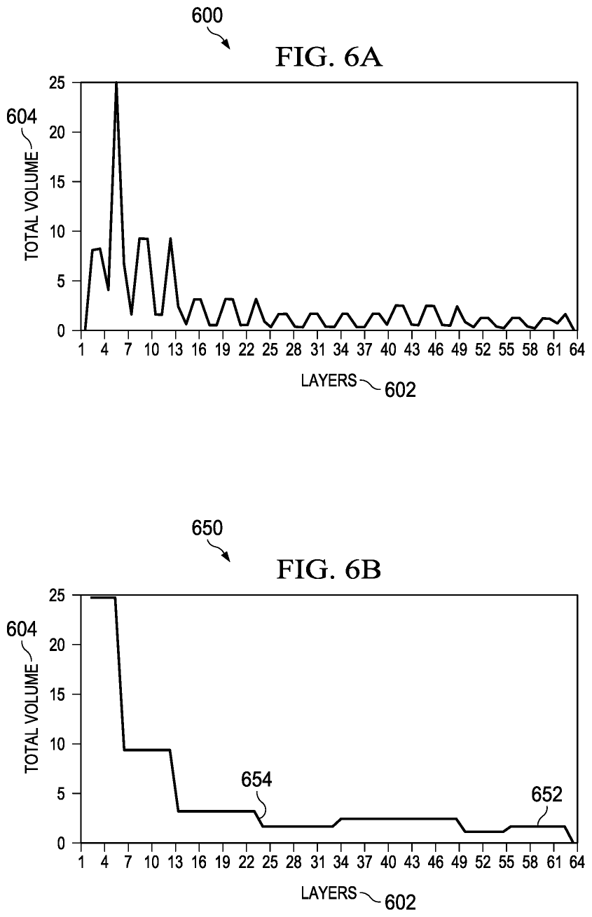

FIG. 6A is a line graph 600 plotting the total volume of memory used for each layer of a CNN, in accordance with aspects of the present disclosure. In FIG, 6A, 64 layers 602 of a CNN are shown on the X-axis and a total value of memory used 604 per layer, in megabytes, are shown on the Y-axis. In this example, the total volume of memory used by layers of the CNN may vary quite a bit as between layers. In accordance with aspects of the present disclosure, this local noise may be addressed by smoothing out the total value of memory used across layers within a window.

FIG. 6B is a line graph 650 plotting a windowed total volume of memory for layers of a CNN, in accordance with aspects of the present disclosure. Windowing is performed across the layers of the CNN to generate the windowed total volume data shown by plot 652. In some cases, a windowed total value for a layer i may be a maximum total volume from layer i to layer i+W where W is a window size. For example, in FIG. 650, the window size may be set to 8 and thus the windowed total volume of layer 1 is the maximum total value for layers 1 through 9. Referring back to line graph 600, layer 5 has the maximum total value for layers 1 through 9, at 25 MB, so the windowed total volume of layer 1 is 25 MB. As another example, at layer 6, the windowed total volume of layer 6 is the maximum total value for layers 6 through 14, or about 9 MB based on layers 8, 9, and 12. In some cases, W may be a predetermined value. For example, W may be coded default value, received from a user, etc. In some cases, W may be dynamically determined based on one or more factors, for example, as a function of a total number of layers in the CNN, the types of layers (e.g., convolutional, deconvolutional, pooling, etc.), as a function of a number of certain types of layers, layer ordering, determined based on a cost function and modeling, etc.

Based on the windowed total volume data, points where the total volume changes by a certain amount, which may be referred to as a volume change factor, may be identified. These identified points may be used to determine initial boundaries for the super tiling groups. In the example line graph 650, points may be identified between layers 5 and 6, layers 12 and 13, layers 24 and 35, and layers 49 and 50. While in this example there is a total volume change between layers 33 and 34 and layers 54 and 55, the total volume change at these points may be below the volume change factor and thus these points are not identified. Thus, five super tiling groups may be defined as including layers [1:5]. [6:12], [13:24], [25:49], and [50:64]. If a relatively smaller volume change factor had been used, additional super tiling groups may be defined, such as [1:5], [6:12], [13:24], [25:49], [50:54], [55:64] or [1:5], [6:12], [13:24], [25:33], [34:49], [50:54], [55:64]. In certain cases, the volume change factor may be predetermined, for example, as a default value, received from a user, etc. In other cases, the volume change factor may be determined based on one or more factors, for example, based on a cache or memory size, a maximum total volume across all layers, ratio of maximum total value to minimum total value, etc. The volume change factor may be chosen to balance noise reduction and a number of points identified. In some cases, multiple volume change factors may be used to determine multiple sets of super tiling groups for comparison, for example, via performance simulations (e.g., modeling).

After the super tiling groups are identified, the super filing groups may be refined. In some cases, super tiling groups may be refined based on a cost minimization performed across super tiling group variants. For example, an initial super tiling group variant may be the super tiling groups as identified based on the total volume changes. A cost factor may be determined and associated with this initial super tiling group variant. This cost factor may be determined based on performance simulations (e.g., modeling) of the CNN being executed using the initial super tiling group variant. The performance simulations may account for memory access latencies, processing speed, and power consumption for a target hardware resource (e.g., the hardware resource CNN execution is being optimized for). The cost factor is then associated with the initial super tiling group variant. A variant of the super tiling group is then determined by moving one or more group boundaries of the super tiling group within a refinement range N of the initial group boundary. In some cases, the refinement range may be both positive and negative and this range may be relatively small. As an example, an initial group boundary 654 may be identified between layers 24 and 25 between initial super tiling groups [13:24], [25:33]; and a refinement range of N=1. The two determined variants of the initial group boundary then may be [13, 23], [24, 33], and [13, 25], [26, 33]. These determined variants may then be evaluated via performance simulations and associated with a cost factor. The variant with the relatively smallest cost factor may be selected as a final super tiling group configuration. In some cases, each group boundary of the initial group boundaries may be refined. In some cases, one group boundaries with a total volume change over or under a certain threshold size may be refined. In some cases, such as when two super thing groups are within the refinement range of each other, the two super tiling groups may be merged. In some cases, different step sizes for the refinement range may be used, for example, adjusting the group boundary by two layers rather than one layer.

In accordance with aspects of the present disclosure, a tile height and number of tiles may be configured for a super tiling group. In some cases, this determination may be based on back propagation from a tile height for the last layer of the super tiling group, such as layer 4 in the example shown in FIG. 5. To determine the tile height via back propagation, the volume of memory needed for each layer may be determined. Based on the volume of memory needed for each layer and an amount of memory available on the target hardware resource, a minimum number of tiles (e.g., passes) needed to process the layer while keeping memory usage of the tile within the amount of memory available on the target hardware resource may be determined. Once minimum number of tiles are determined for each layer, a largest number of the minimum number of tiles for the layers is identified, In some cases, the number of tiles for layers of the group may be constant, except for the first and last pass. Based on this largest number of the minimum number of tiles, tile heights for the last layer may be determined for the first pass, pass, and normal passes. Based on the tile heights for the last layer, tile heights for the layer before the last layer can be determined. This process is then repeated until tile heights for the first layer are determined.

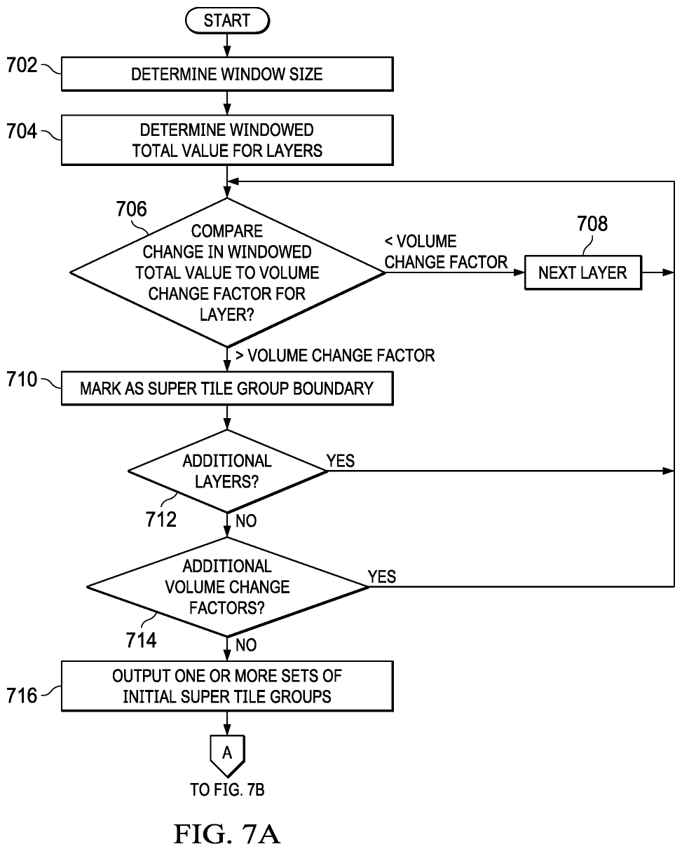

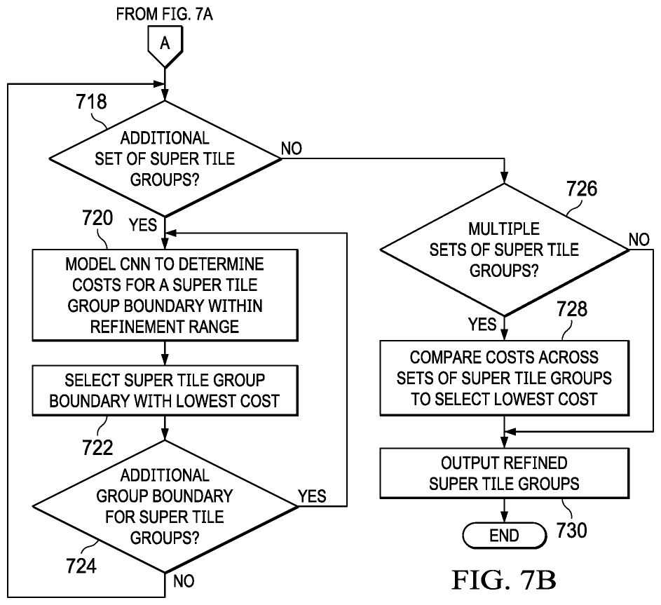

FIGS. 7A and 7B are flowcharts illustrating group boundary determination, in accordance with aspects of the present disclosure. At block 702, a window size is determined. In some cases, the window size may be predetermined and retrieved, for example, from a memory. In some cases, the window size may be determined based on one or more factors, such as the total number of layers of a CNN, cost function, etc. At block 704, windowed total volume of the layers of the CNN may be determined based on the window size. For example, a layer may have a windowed total volume based on a maximum total value of other layers within the window number of the layer. At block 706, a change in the windowed total volume as between a layer and a next layer are compared to a volume change factor. If the windowed total volume change is less than the volume change factor, at block 708, then the next layer, and layer after the next layer, are evaluated at bock 706. If the windowed total volume change is greater than the volume change factor, at block 710, the boundary between the layers is marked as an initial super tile group boundary. At block 712, if there are additional layers, the additional layers are looped through. At block 714, if there are additional volume change factors to consider, the layers of the CNN are looped through again using the additional volume change factors. At block 716, one or more sets of marked initial super tile group boundaries may be output.

At block 718, if there are sets of super tile groups that have not been refined, at block 720, the CNN may be modeled to determine cost factor for a super tile group boundary within a refinement range. For example, a CNN may be modeled by executing the CNN with simulated inputs and using a super tile grouping being modeled. The modeling may use simulated target hardware, such as by using a virtual machine, and record operational information, such as memory usage, latencies of the memories being used, processor usage, power consumptions, etc. In some cases, each variant of a super the group boundary within a refinement range may be simulated and a cost factor associated with the variant. At block 722, the variant with the lowest cost factor of the variants of the super tile group boundary within the refinement range may be selected as the super tile group boundary. At block 724, if there are additional super tile group boundaries to evaluate, execution returns to 720 to evaluate those additional super tile group boundaries. If there are no more super tile group boundaries to evaluate, execution returns to 718. If there are no additional sets of super tile groups to evaluate at block 718, then, if there are multiple sets of refined super tile groups, at block 726, cost factors across the multiple sets of refined super tile groups are compared to select a set of refined super tile groups with a lowest cost factor at block 728. Otherwise, the refined super tile groups are output at block 730.

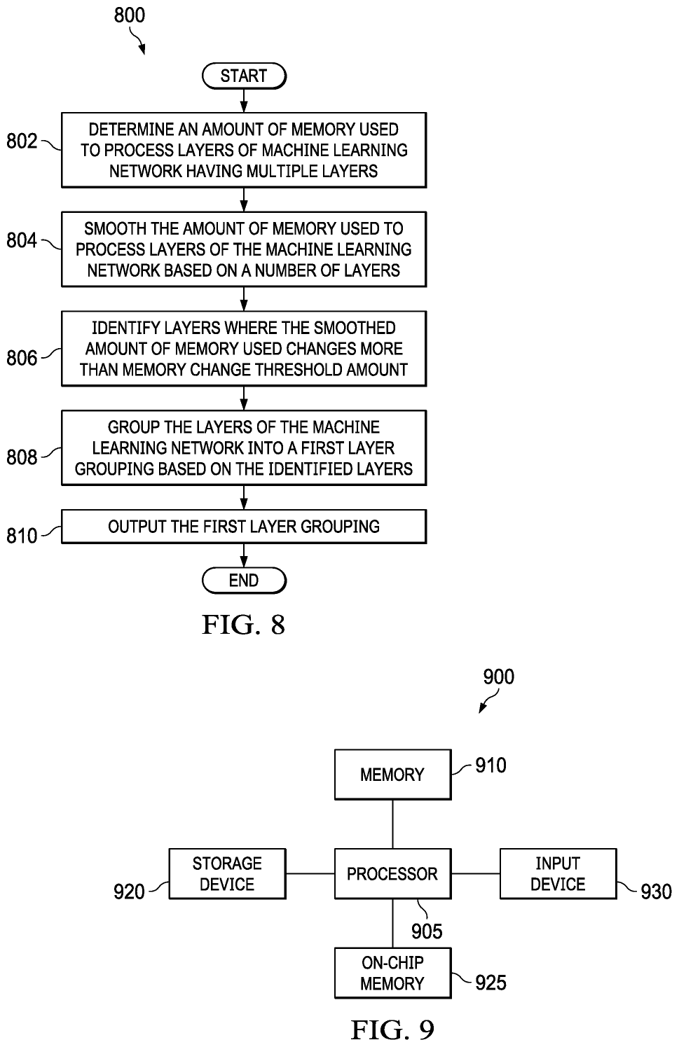

FIG. 8 is a flow diagram illustrating a technique 800 for determining a layer grouping, in accordance with aspects of the present disclosure. At block 802, an amount of memory used to process the layers of a machine learning network having multiple layers are determined. For example, a CNN may be executed with simulated inputs to determine memory usage by layers of the CNN. At block 804, the amount of memory used to process the layers of the machine learning network may be smoothed based on a number of layers. For example, the amount of memory used to process the layers of the CNN may smoothed using a window. The window may have a window size indicating a number of layers included in the window. In some cases, the smoothed amount of memory may be based on the largest amount of memory used by any layers within the rolling window. At block 806, layers where the smoothed amount of memory used changes more than a memory change threshold amount are identified. For example, points where the smoothed amount of memory used changes by more than a volume change factor may be identified as boundaries. At block 808, the layers of the machine learning network may be grouped into a first layer grouping based on the identified layers. For example, super tiling groups may be defined based on the identified boundaries. At block 810, the first layer grouping is output.

As illustrated in FIG. 9, device 900 includes a processing element such as processor 905 that contains one or more hardware processors, where each hardware processor may have a single or multiple processor cores. Examples of processors include but are not limited to a central processing unit (CPU) or a microprocessor. Although not illustrated in FIG. 9, the processing elements that make up processor 905 may also include one or more other types of hardware processing components, such as graphics processing units (GPUs), application specific integrated circuits (ASICs), field-programmable gate arrays (FPGAs), and/or digital signal processors (DSPs). In certain cases, processor 905 may be configured to perform the tasks described in conjunction with FIGS. 7-8.

The processor 905 is operatively and communicatively coupled to on-chip memory 925, such as a cache memory, SRAM, registers, etc. With respect to cache memory, cache memory may include one or more L1 caches, one or more L2 caches, and one or more L3 caches. The L1 cache may be integrated in a package with the processor 905. The L2 and/or L3 caches may also be integrated in the processor package or may be in a package separate from the processor package. In certain cases, the L2 and/or L3 caches, or portions thereof may be integrated with a memory controller, which helps manage memory traffic to the processor 905.

FIG. 9 illustrates that memory 910 may be operatively and communicatively coupled to processor 905. Memory 910 may be a non-transitory computer readable storage medium (e.g., non-transitory program storage device) configured to store various types of data. For example, memory 910 may include one or more volatile devices such as random-access memory (RAM). In certain cases, the SRAM and circuits as described in FIGS. 4-8 may be part of the memory 910. Non-volatile storage devices 920 (e.g., non-transitory program storage device) can include one or more disk drives, optical drives, solid-state drives (SSDs), tap drives, flash memory, electrically programmable read only memory (EEPROM), and/or any other type memory designed to maintain data for a duration of time after a power loss or shut down operation. The non-volatile storage devices 920 may also be used to store programs that are loaded into the RAM when such programs are executed.

Persons of ordinary skill in the art are aware that software programs may be developed, encoded, and compiled in a variety of computing languages for a variety of software platforms and/or operating systems and subsequently loaded and executed by processor 905. In one example, the compiling process of the software program may transform program code written in a programming language to another computer language such that the processor 905 is able to execute the programming code. For example, the compiling process of the software program may generate an executable program that operates a ML network.

After the compiling process, the encoded instructions may then be loaded as computer executable instructions or process steps to processor 905 from storage 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900. Storage 920 may be partitioned or split into multiple sections that may be accessed by different software programs. For example, storage 920 may include a section designated for specific purposes, such as storing program instructions or data for updating software of the computing device 900. In one example, the software to be updated includes the ROM, or firmware, of the computing device. In certain cases, the computing device 900 may include multiple operating systems. For example, the computing device 900 may include a general-purpose operating system which is utilized for normal operations. The computing device 900 may also include another operating system, such as a bootloader, for performing specific tasks, such as upgrading and recovering the general-purpose operating system, and allowing access to the computing device 900 at a level generally not available through the general-purpose operating system. Both the general-purpose operating system and another operating system may have access to the section of storage 920 designated for specific purposes.

The one or more communications interfaces may include a radio communications interface for interfacing with one or more radio communications devices. In certain cases, elements coupled to the processor may be included on hardware shared with the processor. For example, the communications interfaces 925, storage, 920, and memory 910 may be included, along with other elements such as the digital radio, in a single chip or package, such as in a system on a chip (SOC). Computing device may also include input and/or output devices, not shown, examples of which include sensors, cameras, human input devices, such as mouse, keyboard, touchscreen, monitors, display screen, tactile or motion generators, speakers, lights, etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Modifications are possible in the described embodiments, and other embodiments are possible, within the scope of the claims.

What is claimed is:

1. A method comprising:
determining an amount of memory used to process layers of a machine learning network having multiple layers;
smoothing the amount of memory used to process the layers of the machine learning network based on a number of layers;
identifying change layers where the smoothed amount of memory used changes more than a memory change threshold amount;
grouping the layers of the machine learning network into a first layer grouping based on the identified change layers; and
outputting the first layer grouping.

2. The method of claim 1, further comprising:
modeling the machine learning network based on the first layer grouping;
associating a first cost with the first layer grouping;
generating a second layer grouping by adjusting a group boundary of the first layer grouping;
modeling the machine learning network based on the second layer grouping;
associating a second cost with the second layer grouping; and
outputting a lower cost layer grouping based on a comparison between the first cost and the second cost.

3. The method of claim 2, wherein the first and second costs are based on at least one of expected number of memory accesses or processing cycles.

4. The method of claim 2, wherein the group boundary is adjusted within a predefined range of values around the group boundary.

5. The method of claim 1, wherein the first layer grouping comprises a first set of layers and a second set of layers.

6. The method of claim 5, wherein a first number of layers of the first set of layers differs from a second number of layers of the second set of layers.

7. The method of claim 1, further comprising:
determining a minimum number of tiles for the layers of the first layer grouping based on the amount of memory used by the layers;
determining a number of tiles for a last layer of the first layer grouping based on the minimum number of tiles; and
determining the number of tiles for other layers of the first layer grouping based on the number of tiles for the last layer.

8. A non-transitory program storage device comprising instructions stored thereon to cause one or more processors to:
determine an amount of memory used to process layers of a machine learning network having multiple layers;
smooth the amount of memory used to process the layers of the machine learning network based on a number of layers;
identify change layers where the smoothed amount of memory used changes more than a memory change threshold amount;
group the layers of the machine learning network into a first layer grouping based on the identified change layers; and
output the first layer grouping.

9. The non-transitory program storage device of claim 8, wherein the instructions further cause the one or more processors to:
model the machine learning network based on the first layer grouping;
associate a first cost with the first layer grouping;
generate a second layer grouping by adjusting a group boundary of the first layer grouping;
model the machine learning network based on the second layer grouping;
associate a second cost with the second layer grouping; and
output a lower cost layer grouping based on a comparison between the first cost and the second cost.

10. The non-transitory program storage device of claim 9, wherein the first and second costs are based on at least one of expected number of memory accesses or processing cycles.

11. The non-transitory program storage device of claim 9, wherein the group boundary is adjusted within a predefined range of values around the group boundary.

12. The non-transitory program storage device of claim 8, wherein the first layer grouping comprises a first set of layers and a second set of layers.

13. The non-transitory program storage device of claim 12, wherein a first number of layers of the first set of layers differs from a second number of layers of the second set of layers.

14. The non-transitory program storage device of claim 8, wherein the instructions further cause the one or more processors to:
determine a minimum number of tiles for the layers of the first layer grouping based on the amount of memory used by the layers;
determine a number of tiles for a last layer of the first layer grouping based on the minimum number of tiles; and
determine the number of tiles for other layers of the first layer grouping based on the number of tiles for the last layer.

15. A device, comprising:
a memory; and
one or more processors operatively coupled to the memory, wherein the one or more processors are configured to execute non-transitory instructions causing the one or more processors to:
determine an amount of memory used to process layers of a machine learning network having multiple layers;
smooth the amount of memory used to process the layers of the machine learning network based on a number of layers;
identify change layers where the smoothed amount of memory used changes more than a memory change threshold amount;
group the layers of the machine learning network into a first layer grouping based on the identified change layers; and
output the first layer grouping.

16. The device of claim 15, wherein the instructions further cause the one or more processors to:
model the machine learning network based on the first layer grouping;
associate a first cost with the first layer grouping;
generate a second layer grouping by adjusting a group boundary of the first layer grouping;
model the machine learning network based on the second layer grouping;
associate a second cost with the second layer grouping; and
output a lower cost layer grouping based on a comparison between the first cost and the second cost.

17. The device of claim 16, wherein the first and second costs are based on at least one of expected number of memory accesses or processing cycles.

18. The device of claim 16, wherein the group boundary is adjusted within a predefined range of values around the group boundary.

19. The device of claim 15, wherein the first layer grouping comprises a first set of layers and a second set of layers.

20. The device of claim 15, wherein the instructions further cause the one or more processors to:
determine a minimum number of tiles for the layers of the first layer grouping based on the amount of memory used by the layers;
determine a number of tiles for a last layer of the first layer grouping based on the minimum number of tiles; and
determine the number of tiles for other layers of the first layer grouping based on the number of tiles for the last layer.
